(19) United States
(12) Patent Application Publication
(10) Pub. No.: US 2024/0178415 A1
(43) Pub. Date: May 30, 2024

(54) DEVICE FOR SEPARATING AND COLLECTING WATER FROM A GAS STREAM, FUEL CELL SYSTEM, AND METHOD FOR OPERATING A FUEL CELL SYSTEM

(71) Applicant: Robert Bosch GmbH, Stuttgart (DE)

(72) Inventors: Martin Katz, Stuttgart (DE); Wolfgang Sander, Weissach (DE)

(21) Appl. No.: 18/551,716

(22) PCT Filed: Mar. 22, 2022
(86) PCT No.: PCT/EP2022/057440

§ 371 Date: Sep. 21, 2023

(30) Foreign Application Priority Data
Mar. 24, 2021 (DE) 10 2021 202 857.8

(51) Int. Cl. H01M 8/04119; B01D 53/26

(52) U.S. Cl. CPC H01M 8/04164; B01D 53/265; H01M 8/04126; B01D 2257/80; B01D 2258/0208

(57) ABSTRACT

The invention relates to a device (1) for separating and collecting water from a gas stream, comprising a water separator (2), configured as a riser, and a water tank (3) which is arranged below the water separator (2), wherein the water separator (2) has, at its lower end, an outlet (4) which opens into the water tank (3), a lateral gas inlet (5), and a gas outlet (6) which is arranged at its upper end.

The invention also relates to a fuel cell system (20) with a corresponding device (1) and to a method for operating a fuel cell system (20).

### BACKGROUND

The invention relates to a device for separating and collecting water from a gas stream. The gas flow may in particular be air that exits from at least one fuel cell during operation of a fuel cell system. The device is therefore preferably used in a fuel cell system.

The invention therefore further relates to a fuel cell system having a device according to the invention, as well as a method for operating a fuel cell system in which a device according to the invention is used to separate and collect water from a gas stream.

Fuel cells convert a fuel, for example hydrogen, and oxygen into electrical energy, heat, and water. Air, in particular ambient air, can serve as the oxygen supplier. The air is supplied via a supply air path to a cathode of the fuel cells. As the energy conversion process requires a certain mass air flow and a certain pressure level, the cathode-side supplied air is compressed with the aid of an air compressor arranged in the supply air path. Prior to entering the fuel cells, the air is also humidified to prevent drying of the membranes of the fuel cells. Otherwise, there is a risk of the fuel cells becoming damaged.

For humidification, a gas-to-gas membrane humidifier may be used, which transports water, in particular product water, that accumulates during operation of the fuel cells, from the exit side to the entry side of the fuel cells. However, such humidifiers can only transport water if water is currently available on the “moist” side. Other cathode-side or anode-side water is typically discharged into the environment via the exhaust gas system.

### SUMMARY

The present invention is therefore concerned with the task of optimizing the separation of water from a gas stream in order to supply this water for use.

To solve this problem, the device according to the disclosure and the fuel cell system according to the disclosure are proposed. Moreover, a method for operating a fuel cell system is provided.

The proposed device for separating and collecting water from a gas stream comprises a water separator configured as a riser and a water tank which is arranged below the water separator, wherein the water separator has, at its lower end, an outlet which opens into the water tank, a lateral gas inlet, and a gas outlet which is arranged at its upper end. Accordingly, the gas flow passes through the water separator of the device from bottom to top. Liquid water contained in the gas flow is thereby—driven by gravity—separated and directed into the water tank via the outlet. The gas exits the water separator in the reverse direction via the gas outlet provided at the top end.

Water collected in the water tank may be provided for use, for example, to humidify the air in a supply air path of a fuel cell system. In this case, the device may be integrated into an exhaust air path of the fuel cell system, such that the moist air or exhaust air exiting from at least one fuel cell of the fuel cell system is fed to it. In this way, a sufficiently large amount of water may be separated and collected to humidify the air fed to the fuel cell.

To optimize water separation, it is proposed that an element that promotes the condensation of water vapor in the water separator is arranged between the gas inlet and the gas outlet, for example in the form of a grid or a body made of a porous material. If the gas flow rising into the water separator still contains water in the form of water vapor, this can condense on the element and also be discharged into the water tank.

Alternatively or additionally, it is proposed that a Venturi nozzle is connected upstream of the gas inlet, which is connected to the water tank in the area of a cross-sectional constriction via a riser. In this way, a secondary flow may be generated with the aid of which gas that enters the water tank with the separated water is drawn in via the riser and fed to the water separator again. Gas that collects in the water tank is thus exchanged or at least diluted. This is particularly advantageous when a hydrogen-containing gas stream is supplied to the device. In this case, with the aid of the Venturi nozzle, an explosive accumulation of hydrogen can be prevented from collecting in the water tank.

Furthermore, the water separator and/or the water tank may have a shape that increases the internal surface or may have fixtures, for example in the form of plates, ribs, or tubes. This measure also leads to an optimization of the water separation. More water vapor may condense on the enlarged internal surface. This applies in particular when the internal surface is comparatively cool. For example, ambient air may be used for cooling, which is typically cooler than the exhaust air in a fuel cell system. As a further design measure, it is therefore proposed that the fixtures of the water separator and/or the water tank are hollow at least in certain areas and can be exposed to ambient air. In this way, the cooling of the gas stream that promotes condensation can be achieved.

Furthermore, it is proposed that the water tank can be heated by means of a heating device, which is preferably arranged on the bottom side. If water present in the water tank freezes during shutdown, it can be quickly thawed with the aid of the heating device. In this way, when the device is used in a fuel cell system, the freeze start capability of the system can be improved.

In further development of the invention, it is proposed that a pump for removing water is arranged in or on the water tank. Since the water is not only to be separated and collected, but also to be supplied for use, the pump can be used to selectively remove water from the water tank and deliver it to the location of use. For example, in a fuel cell system, this may be a supply path through which air is supplied to the at least one fuel cell. With the aid of water removed from the water tank, the air can then be humidified before entering the fuel cell.

If more water is collected in the water tank than is removed over time, the water tank may overflow. To prevent this, a valve for draining water may be arranged on the water tank.

Preferably, the water tank comprises at least one further connection for introducing a gas and/or water flow. When using the device in a fuel cell system, for example, a quantity of gas may be introduced via the at least one further inlet, which is discharged from an anode circuit of the system via a purge valve. Alternatively, or additionally, water from a further water separator may be supplied to the water tank via the at least one further connection. This may be arranged on the anode side or cathode side, for example upstream of a turbine integrated in the exhaust air path. In this way, all separated water can be collected in the water tank of the device and, if necessary, supplied for use.

As the proposed device is preferably used in a fuel cell system, a fuel cell system is further proposed. This comprises at least one fuel cell with an exhaust air path for dissipating air exiting the fuel cell and a device according to the invention integrated into the exhaust air path. As moist air exits from a fuel cell, water contained in the air can be separated and collected with the aid of the device according to the invention. This, in turn, allows the water to be supplied for use, for example to humidify the air supplied to the fuel cell via a supply air path.

Preferably, the device for separating and collecting water downstream of a turbine is integrated into the exhaust air path. The turbine is used for energy recovery. The relaxation of the air as it passes through the turbine promotes the condensation of water vapor, so that this water can also be retained with the aid of the device.

If a turbine is arranged in the exhaust air path, it is proposed in the further development of the invention that a water separator connected to the water tank of the device according to the invention is arranged in the exhaust air path, preferably upstream of the turbine. The further water separator arranged upstream of the turbine draws water from the moist exhaust air before it enters the turbine. In this way, damage to the turbine can be avoided, for example by droplet impact or droplet erosion. The water separated with the aid of the water separator may then also be fed to and collected from the water tank so that only one water tank is required.

Alternatively, or additionally, the water tank of the device according to the invention may be connected to a drain valve and/or purge valve arranged on the anode side. The drain valve can be used to introduce water into the water tank that has been separated with the aid of a water separator arranged on the anode side to remove water from an anode circuit of the fuel cell system. Anode gas discharged on the anode side can be introduced into the water tank via the purge valve, which also contains water in addition to hydrogen and nitrogen. If a secondary flow generated in the water tank with the aid of a Venturi nozzle is present, it is ensured that the hydrogen introduced into the water tank is sufficiently diluted and also discharged again. In this way, no hazardous accumulation of hydrogen may form in the water tank.

To solve the abovementioned problem, a method for operating a fuel cell system with at least one fuel cell is also proposed. In the method, air exiting from the fuel cell is supplied to a device according to the invention so that water contained in the air is separated and collected. The method further uses the water collected in the water tank to humidify air supplied to the fuel cell via a supply air path

Using the method, the water separation rate may be increased because the moist air discharged via the exhaust air path is withdrawn from the water that is typically discharged into the environment with the exhaust air or exhaust gas of the fuel cell system. At the same time, the water can be supplied for use, so that the efficiency of the system is increased with the aid of the method.

### BRIEF DESCRIPTION OF THE DRAWINGS

A preferred embodiment of the invention is explained in further detail below with reference to the accompanying drawings. Shown are:

FIG. 1 a schematic illustration of a device according to the invention, and

FIG. 2 a schematic illustration of a fuel cell system according to the invention.

### DETAILED DESCRIPTION

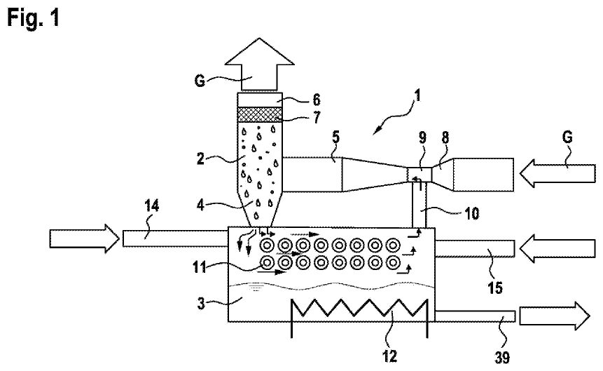

The device 1 according to the invention shown in FIG. 1 comprises a water separator 2 and a water tank 3. The water tank 3 is arranged below the water separator 2, so that water separated in the water separator 2 from a gas flow G passes into the water tank 3 via a drain 4, driven by gravity. The gas flow G passes into the water separator 2 via a lateral gas inlet 5 just above the outlet 4. In the water separator 2, the gas flow G is redirected and supplied to a gas outlet 6 at the upper end of the water separator 2. The gas flow G passes through an element 7 in the form of a grid, where water vapor contained in the gas flow G can condense. The condensate then drips from element 7 via drain 4 into water tank 3.

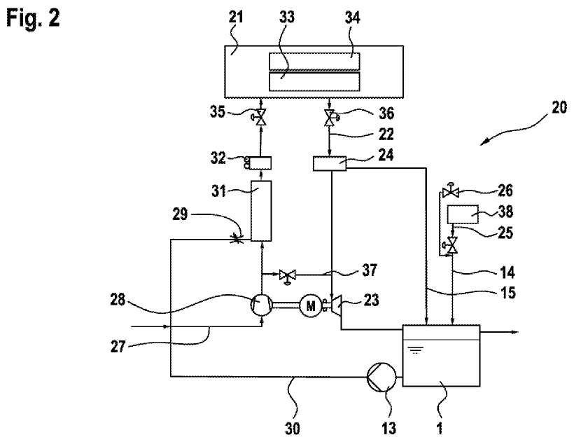

A Venturi nozzle 8 is connected upstream of the gas inlet 5, with the aid of which a secondary flow in the water tank 3 can be generated. This is because a cross-sectional constriction 9 of the Venturi nozzle 8 is connected to the water tank 3 via a riser 10, so that gas is drawn from the water tank 3 and supplied to the water separator 2 via the Venturi nozzle 8. In this way, the gas present in the water tank 3 is exchanged and discharged with the gas flow G. This is particularly advantageous when—as exemplified in FIG. 1—the water tank 3 is connected to a purge valve 26 via a connection 14, such that hydrogen-containing anode gas is supplied from an anode circuit of a fuel cell system 20 to the water tank 3 (see FIG. 2). This prevents the hydrogen from collecting in water tank 3. Instead, it is diluted and discharged. The water tank 3 can be connected via the outlet 14—alternatively or additionally—to a drain valve 25 via which a water separator 38 arranged on the anode side is emptied (see FIG. 2). In this case, this water may also be collected in water tank 3 and supplied for use if necessary. In the present case, a further connection 15 connects the water tank 3 to a water separator 24, which is arranged upstream of a turbine 23 (see FIG. 2), such that this water is also supplied to the water tank 3.

To optimize the water separation, the water tank 3 shown has fixtures 11 in the form of tubes, which pass through the water tank 3 and are filled with ambient air. If this is cooler than the gas present in the water tank 3, which will usually be the case, water vapor can condense on the surfaces of the fixtures 11 and drip downwards.

The water tank 3 shown further comprises a heating device 12 arranged on the bottom side, which is intended to prevent water from freezing at low outside temperatures or—if water is already frozen—to enable rapid thawing. The heating device 11 is therefore arranged in the area of a bottom-side outlet 39, via which water can be removed from the water tank 3, for example with the aid of a pump 13 (see FIG. 2).

FIG. 2 shows a fuel cell system 20 with a fuel cell 21 and a device 1 according to the invention. The device 1 is arranged in an exhaust air path 22, via which moist air or exhaust air exiting the fuel cell 21 is discharged. The air or exhaust air is first fed to a water separator 24 to remove a portion of the water it contains to protect a downstream turbine 23. After the turbine 23, the air or exhaust air enters the device 1, such that the remaining contained water is removed and collected in the water tank 3.

The water collected in the water tank 3 is used in the system illustrated for humidifying air that is supplied to the fuel cell 21 via a supply air path 27. For humidification, a valve unit 29 is used, which is integrated downstream of an air compressor 28 in the supply air path 27. The valve unit 29 is connected to the pump 13 via a water line 30, which is used to remove water from the water tank 3 of the device 1. With the aid of the valve unit 29, the water is finely atomized when introduced, so that it quickly evaporates in the air that was previously compressed and heated. As the water flows through a mixing section 31 integrated into the supply air path 27, it mixes with the air so that a good moisture distribution is achieved. Via the mixing section 31, the compressed and humidified air reaches a heat exchanger 32, which is also integrated into the supply air path 27. This serves to cool the air before it is fed to a cathode 33 of the fuel cell 21.

In order to prevent the entry of air into the cathode 33 in the shutdown case, a shut-off valve 35 is arranged in the supply air path 27. Another shut-off valve 36 prevents air from passing back into the fuel cell 21 from the exhaust air path 22. Furthermore, a bypass valve 37 is provided to bypass the fuel cell 21, which when open connects the supply air path 27 to the exhaust air path 22.

In addition to the cathode 33, the fuel cell 21 comprises an anode 34, which is supplied with hydrogen during operation of the system via an anode circuit (not shown). In FIG. 2, only the water separator 38 arranged on the anode side, including the drain valve 25 and the purge valve 26, are shown, as a connection of the device 1 according to the invention with the anode side of the system can be made via these.

1. A device (1) for separating and collecting water from a gas stream,
comprising a water separator (2), configured as a riser and a water tank (3) which is arranged below the water separator (2), wherein the water separator (2) has, at a lower end, an outlet (4) which opens into the water tank (3), a lateral gas inlet (5), and a gas outlet (6) which is arranged at an upper end.

2. The device (1) according to claim 1,
wherein an element (7) that promotes condensation of water vapor in the water separator (2) is arranged between the gas inlet (5) and the gas outlet (6).

3. The device according to claim 1,
wherein a Venturi nozzle (8) is connected upstream of the gas inlet (5), and is connected to the water tank (3), in an area of a cross-sectional constriction (9), via a riser (10).

4. The device according to claim 1, wherein the water separator have a shape that increases an internal surface or have fixtures (11) in the form of plates, ribs or tubes.

5. The device according to claim 4,
wherein the fixtures (11) are hollow at least in certain areas and are configured to be exposed to ambient air.

6. The device according to claim 1, wherein the water tank (3) is configured to be heated by means of a heating device (12), which is preferably arranged on the bottom side.

7. The device according to claim 1, wherein a pump (13) for removing water and/or a valve for draining water is arranged in or on the water tank (3).

8. The device according to claim 1, wherein the water tank (3) comprises at least one further connection (14, 15) for introducing a gas and/or water flow.

9. A fuel cell system (20) comprising at least one fuel cell (21) having an exhaust air path (22) for dissipating air exiting the fuel cell (21), wherein a device (1) according to claim 1 is integrated into the exhaust air path (22).

10. The fuel cell system (20) according to claim 9, wherein the device (1) is integrated downstream of a turbine (23) in the exhaust air path (22).

11. The fuel cell system (20) according to claim 9, wherein a water separator (24) is arranged in the exhaust air path (22) and is connected to the water tank (3) of the device (1).

12. The fuel cell system (20) according to claim 9, wherein the water tank (3) of the device (1) is connected to a drain valve (25) and/or purge valve (26) arranged on an anode side.

13. A method for operating a fuel cell system (20) having at least one fuel cell (21) in which air exiting the fuel cell (21) is supplied to a device (1) according to claim 1, such that water contained in the air is separated and collected, and in which water collected in the water tank (3) is used to humidify air supplied to the fuel cell (21) via an supply air path (27).

14. The device according to claim 2, wherein the element (7) that promotes condensation of water vapor is a grid or a body made of a porous material.

15. The device according to claim 6, wherein the heating device (12) is arranged on a bottom side of the water tank (3).

16. The fuel cell system (20) according to claim 11, wherein the water separator (24) is upstream of a turbine (23) in the exhaust air path (22).
